(19) United States
(12) Patent Application Publication
(10) Pub. No.: US 2004/0155756 A1
(43) Pub. Date: Aug. 12, 2004

(54) Synchronous/programmed flare control method

(76) Inventors: Sung Ying Liu, Taipei (TW); Szu-Chin Chang, Taipei (TW); Chun-Hao Thao, Taipei (TW)

Correspondence Address: LIU Sung Ying, PO Box 82-144, Taipei, TW

(21) Appl. No.: 10/364,566

(22) Filed: Feb. 12, 2003

(51) Int. Cl. H01S 3/00

(52) U.S. Cl. 340/309.16

(57) ABSTRACT

A synchronous and/or programmed flare control method for an outdoor light signal group is designed by having coordinated universal time from the global position system and planned control of the light source group to achieve sync-programming flare; power source for each light source being separately connected to allow maximal cable layout flexibility without having to provide signal cable between controller and each light signal.

### BACKGROUND OF THE INVENTION

(a) Field of the Invention

The present invention is related to a synchronous and/or programmed flare control method for an outdoor light signal group, and more particularly, to one has the coordinated universal time (UTC) emitted by the global position system (GPS) as a common time-base for the control of outdoor or remote light source to achieve the design of a decentralized control system (DCS).

(b) Description of the Prior Art

Outdoor light signal groups, such as the fixed traffic index guide or provisional warning device on highway, or long-distance geographic boundary index provided on waterway in a port or along a plateau, or for decoration or AD box on a building or road, generally flare to achieve better visibility. Cable connection is required for the conventional outdoor light signal groups to have synchronous or programmed flare effects. Accordingly, each light signal must be connected to a power source and an additional control cable is required, resulting in work difficulty and higher cost. Furthermore, in case of excessively long outdoor cable, it is vulnerable to be broken up by pull of external force resulting in breakdown of the entire circuit.

### SUMMARY OF THE INVENTION

The primary purpose of the present invention is to provide a method to control synchronous/programmed flare of an outdoor light signal group by having the GPS emitted UTC as the common time-base for the control of outdoor or remote light source to achieve the purpose of decentralized control system. The control method of the present invention provides the following advantages:

1. Erection of control cable other than power cable is not required;

2. Power cable layout is locally accessible depending on the location; and

3. In case of power failure, only a local part of the light signal group is affected and service for restoration is made easier.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a block chart showing the working principle and practice of the present invention.

FIG. 2 is a block chart showing multiple control modules of the present invention operating on the same set of global position system.

FIG. 3 is a schematic view showing an application of the present invention in a series of road guide signs.

FIG. 4 is a schematic view showing another application of the present invention in a series of provisional warning lights in a constructional site.

FIG. 5 is a schematic view showing another application yet of the present invention in geographic boundary marking on a mountain ridge.

FIG. 6 is a schematic view showing another application yet of the present invention in dividing pier boundary and waterway in a seaport.

FIG. 7 is a schematic view showing another application yet of the present invention in remote light strings and road island in festival event.

FIG. 8 is a schematic view showing another application yet of the present invention in a building.

FIG. 9 is a schematic view showing read of time from the global position system by the present invention.

FIG. 10 is a schematic view showing the flare control of a light source by the present invention.

FIG. 11 is a schematic view showing the flare control of light source in fully fixed mode by the present invention.

FIG. 12 is a schematic view showing the flare control of light source by the present invention allowing limited adjustment.

FIG. 13 is a schematic view showing the flare control of light source by the present invention allowing free adjustment.

### DETAILED DESCRIPTION OF THE PREFERRED EMBODIMENT

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

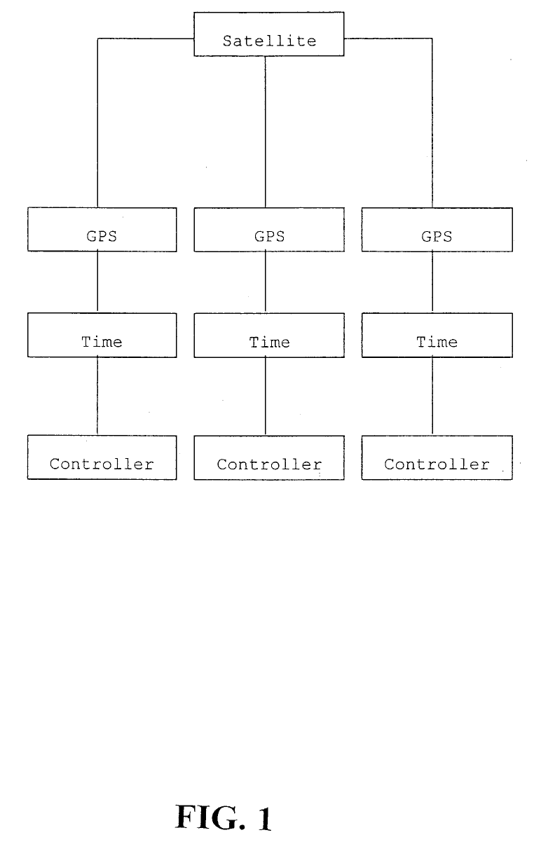

The present invention provides a method to control synchronous and/or programmed flare of an outdoor light signal group. As illustrated in FIG. 1, a coordinated universal time (UTC) emitted by a global position system (GPS) is used as a common time-base for an outdoor or remote light source to achieve the purpose of a decentralized control system (DCS).

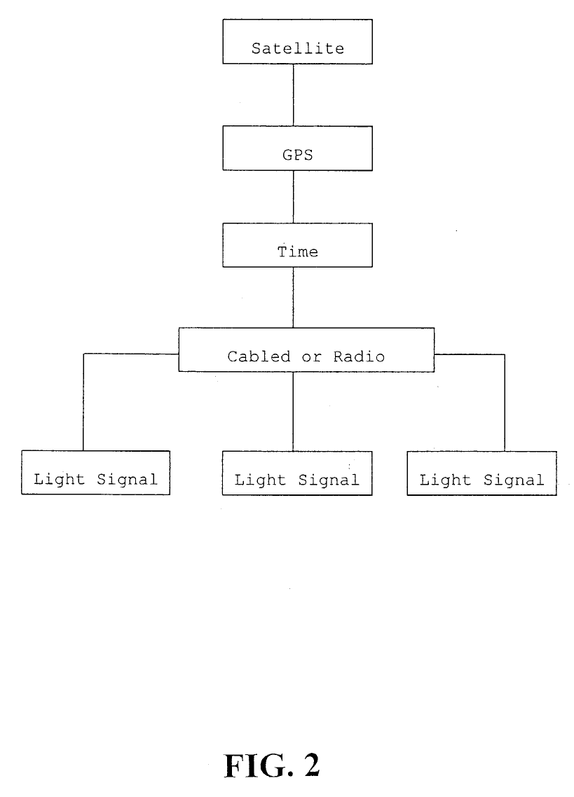

Referring to FIG. 2, multiple sets of control modulus share the same GPS to convert signals into radio signals at lower frequency to lower the cost in average of extended application for each set of control modulus.

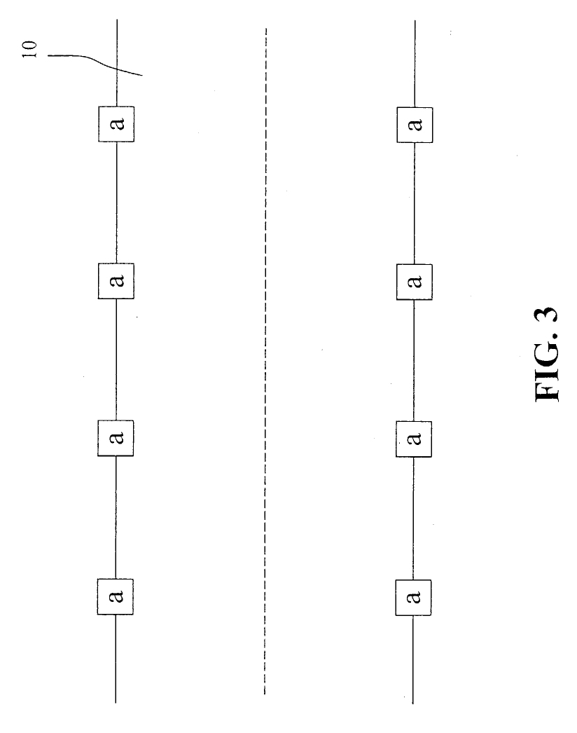

As illustrated in FIG. 3, the present invention is applied in series of road guide sings (a), provided in a foggy road section, road in mountain area, speedway or on the edge of road section (10) where road accident takes place at a higher frequency.

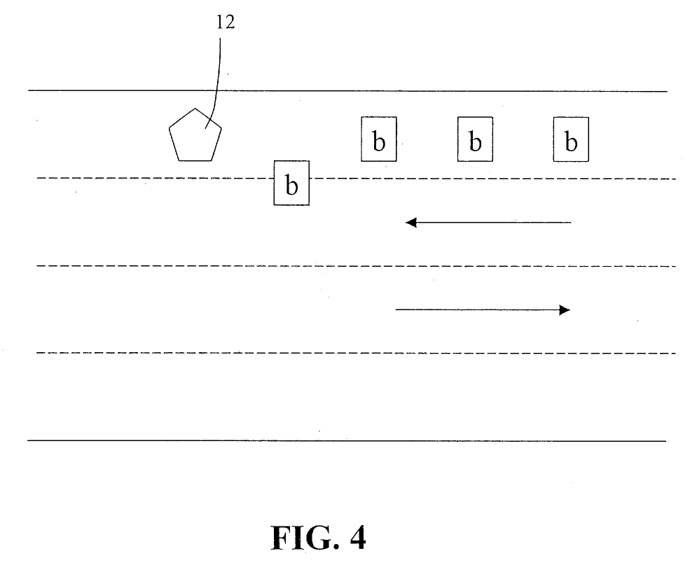

The present invention may be applied in mobile warning lights (b) of provisional roadwork as illustrated in FIG. 4. Wherein, several up to several hundreds of electronically or mechanically controlled flare warning lights are provided at a constructional site (12) to significantly improve warning results and visibility.

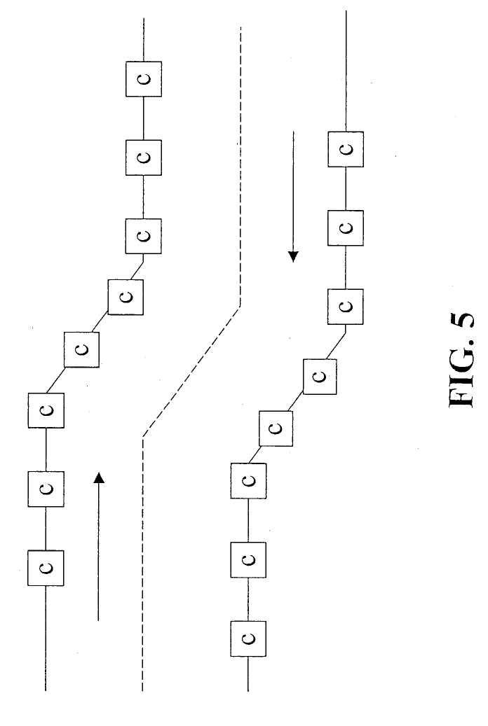

The present invention may be applied in a series of lights (c) to mark geographic boundary including a mountain ridge as illustrated in FIG. 5. Those lights (c) share a same light source for synchronous flare with an airport on a hillside to warn approaching aircrafts.

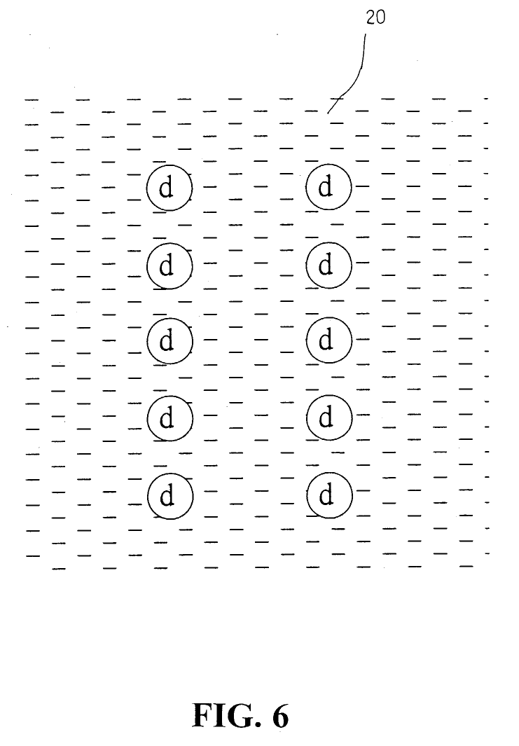

As illustrated in FIG. 6, the present invention is applied in a series of lights (d) to mark divisions of waterway (20) and pier boundary of a seaport. Basically, the marking lights for the pier boundary operate on external power source while the marking lights (d) for dividing the waterway (20) rely upon solar energy to reinforce marking results through the properly design phase.

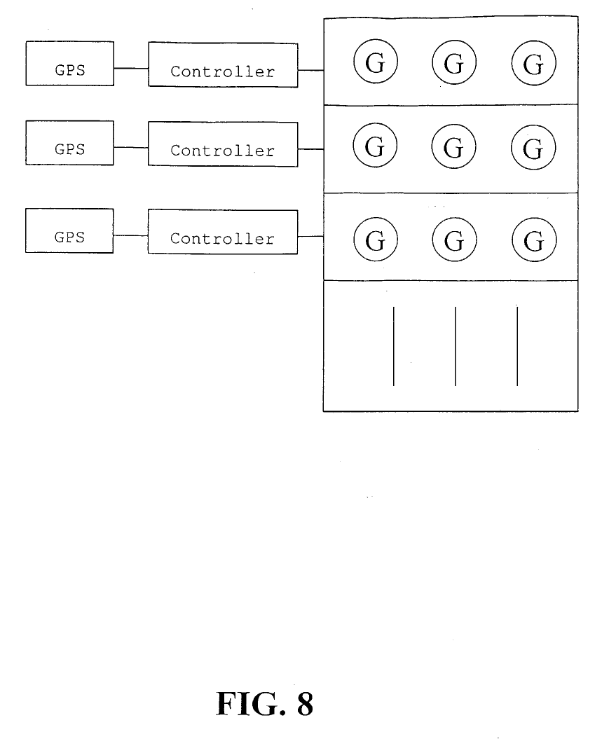

In festival event, the present invention may be applied in the provisional remote light strings (f) or as illustrated in FIG. 6, the present invention is applied in a series of warning lights (e) on a road island; or as illustrated in FIG. 8, in a series of warning light (G) on an external wall of a building to highlight visual effects by having synchronous flare or flare at random.

As for the remote advertisement billboard groups, a design by the application of the present invention may be made for the same owner of those billboard groups without any contact or synchronous device being provided among those billboards.

All the selected applications as described above operate the work principle of synchronous flare to improve visibility and to share the same light source. On the condition of not affecting the susceptibility of visual contact, the lux characteristics of the light source may be significantly reduced for the present invention to be applicable in other preferred embodiments.

Now referring to the application of the present invention in mobile warning lights as illustrated in FIG. 4 for provisional work, higher lux of the device of the prior art may become a potential risk of causing eyes stimulation for the safety of automobile drivers. The risk can be significantly reduced by decreasing the lux.

In the application of the present invention in guide lights on the edge of road as illustrated in FIG. 2, design of lower lux for the guide lights makes it possible to use solar energy as the light source for economic and practical purposes. Similarly, the application of the present invention in the marking lights as illustrated in FIG. 6 on the waterway (20) offers the advantage of higher visibility and power saving.

Lux reduction design also saves long-term maintenance cost and energy consumption for the application of the present invention in the marking of geographic boundary including the mountain ridge line as illustrated in FIG. 5.

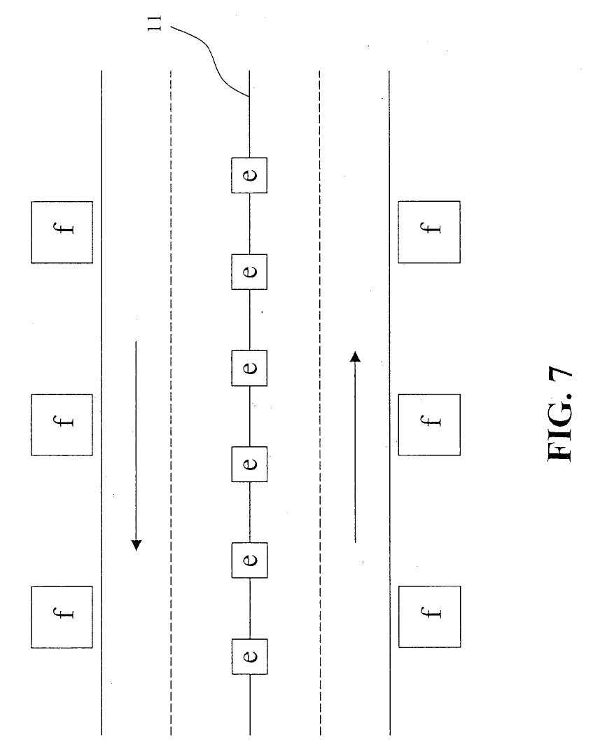

The provisional long range light strings provided in festival event as illustrated in FIG. 7, fewer light sources are required by extending the spacing between abutted light sources without affecting the susceptibility of visual contact.

There are two approaches for the present invention to read time from the GPS for achieving the DCS purpose with UTC signals emitted by the GPS as the common time-base in the control of outdoor or remote light source in the present invention.

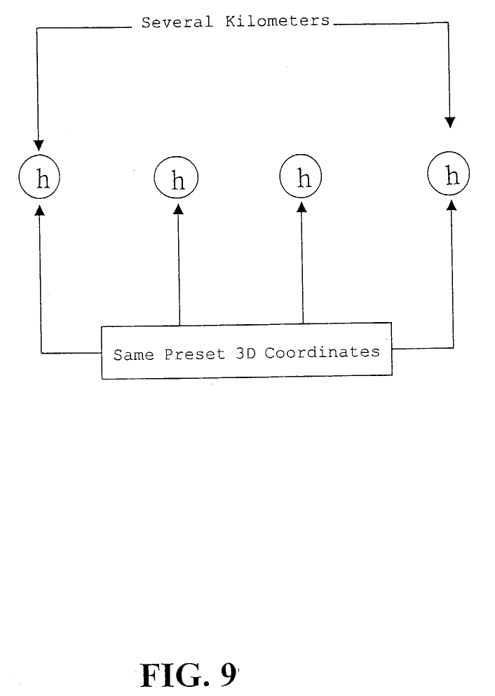

One approach involves the time reading by having parameters (3D coordinates and time) determined by four or more than four satellites. The other approach as illustrated in FIG. 9 involves inputs of pre-determined 3D coordinates so that the reception of signals from only one satellite is sufficient to maintain UTC precession.

10 mS is sufficient for the precision of the time-base in design requirements. The time synchronous error is easy for the GPS. As illustrated in FIG. 9, all the 3D coordinates settings for light sources (h) disposed in a region wherein abutted light sources (h) may be several kilometers separating from each other, are preset at the same value. The resulted time error is insignificant to make the present invention fully feasible. Furthermore, satellite receiver is not required to always operate, and intermittent operation is made possible to control the individual time-base of each light source.

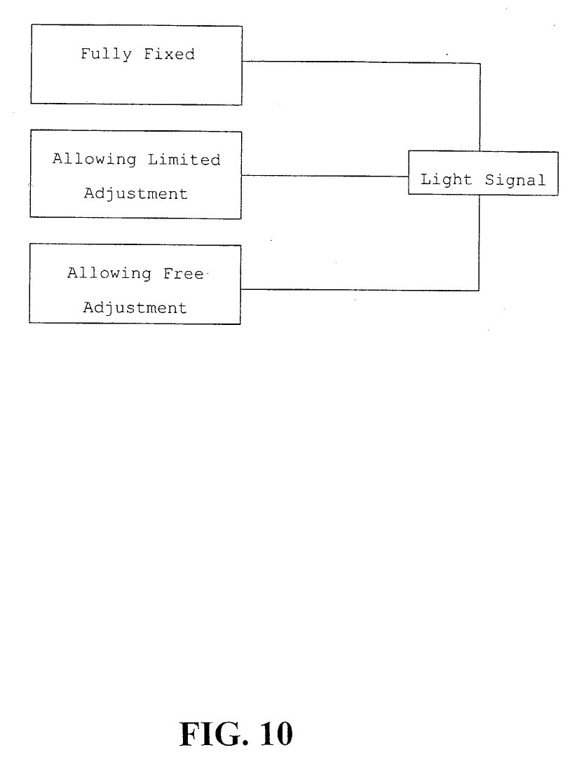

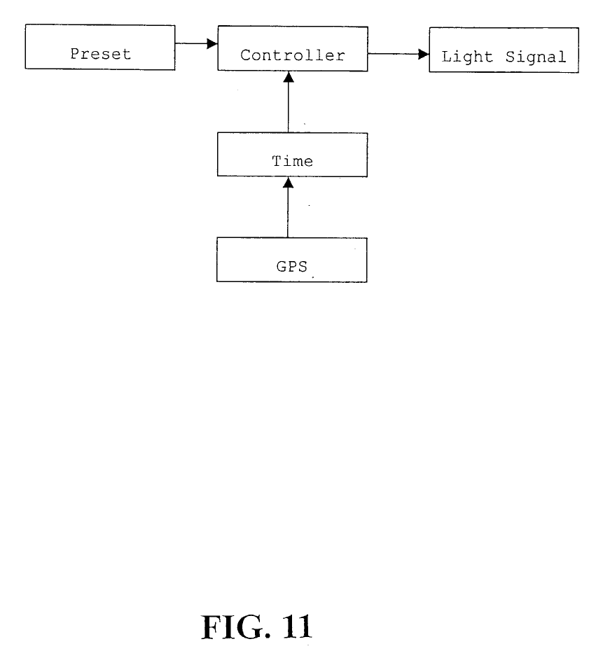

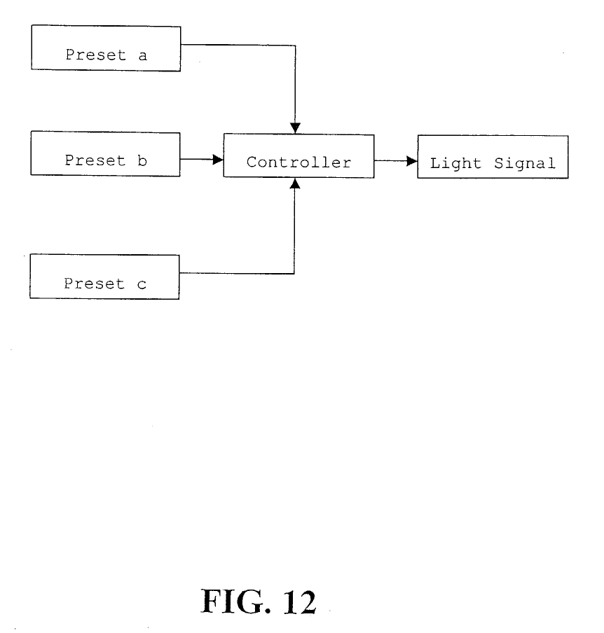

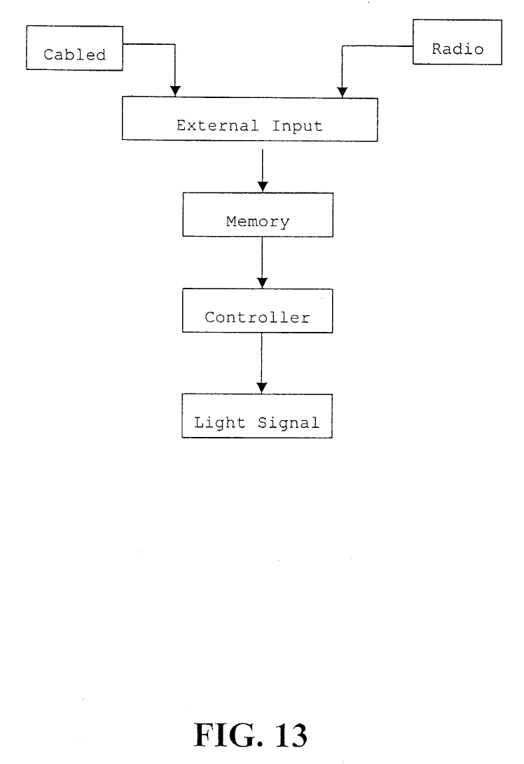

As for the control of the flare pattern of light sources, any method may be selected from three modes as illustrated in FIG. 10. The first mode features completely fixation type as illustrated in FIG. 11 with ex-factory present and no user adjustment is required. As illustrated in FIG. 12, the second mode allows limited options of adjustment by the user with setup switches provided on the product. The third mode as illustrated in FIG. 13 permits free adjustment by the user with RS-232 or IRDA as cabled or radio communication interface, and a PC is used to program time sequence to be transmitted to each individual controller.

It will be understood that each of the elements described above, or two or more together may also find a useful application in other types of methods differing from the type described above.

While certain novel features of his invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A control method for synchronous and/or programmed flare of an outdoor or remote light signal group to achieve decentralized control system purpose by having coordinated universal time signals emitted from global position system as a common time-base.

2. A control method for synchronous and/or programmed flare of an outdoor or remote light signal group as claimed in claim 1, wherein, a device for the light signal group is limited to fixed traffic guide marks or provisional warning device provided on edge of a road; a geographical index showing long range boundary lines in a seaport, waterway or a plateau; and decoration or advertisement light source to a building or road.

3. A control method for synchronous and/or programmed flare of an outdoor or remote light signal group as claimed in claim 1, wherein, all settings for 3D coordinates for multiple light sources (located with several kilometers from one another) within a region are preset at same value to read time signals from the global position system; and intermittent receiving signals from only one satellite is sufficient to maintain synchronous precision of individual time-base of each light source.

4. A control method for synchronous and/or programmed flare of an outdoor or remote light signal group as claimed in claim 1, the flare control of light sources is preset in a fully fixed single flare mode; or in a mode allowing limited adjustment by means of a switch; or cabled such as RS-232 or radio such as IRDA communication interface and a PC are used to transmit individual flare sequence to its respective controller allowing free adjustment of flare pattern.
